(19) United States
(12) Patent Application Publication
(10) Pub. No.: US 2026/0159011 A1
(43) Pub. Date: Jun. 11, 2026

(54) UNIVERSAL RETAINER AND METHOD FOR MANUFACTURING SUCH A UNIVERSAL RETAINER

(71) Applicant: VOLKSWAGEN AKTIENGESELLSCHAFT, Wolfsburg (DE)

(72) Inventor: Lukas THIES, Wolfsburg (DE)

(21) Appl. No.: 19/415,665

(22) Filed: Dec. 10, 2025

(30) Foreign Application Priority Data
Dec. 11, 2024 (DE) 10 2024 137 241.9

(51) Int. Cl. B60R 13/02; B29C 45/33; B29C 45/40; B29L 31/00; B29L 31/30; F16B 2/20

(52) U.S. Cl. CPC B60R 13/0206; B29C 45/33; B29C 45/40; B60R 13/0243; F16B 2/20; B29L 2031/3041; B29L 2031/727

(57) ABSTRACT

A universal retainer for receiving a clip for fastening a vehicle trim of a transportation vehicle, in particular a door trim, to a support component, in particular an inner metal door panel. Disclosed embodiments relate to a method for manufacturing such a universal retainer.

### PRIORITY CLAIM

This patent application claims priority to German Patent Application No. 10 2024 137 241.9, filed 11 Dec. 2024, the disclosure of which is incorporated herein by reference in its entirety.

### SUMMARY

Disclosed embodiments relate to a universal retainer for receiving a clip for fastening a vehicle trim of a transportation vehicle, in particular a door trim, to a support component, in particular an inner metal door panel. Disclosed embodiments relate to a method for manufacturing such a universal retainer.

### BRIEF DESCRIPTION OF THE DRAWINGS

Disclosed embodiments will be described with reference to the figures. The features and feature combinations in the description, as well as the features and feature combinations presented in the figures, may be used not only in the combination respectively indicated but also in other combinations or individually, without departing from the scope of the disclosure. In the drawings:

FIG. 1 schematically shows a side view of a universal retainer according to an exemplary embodiment,

FIG. 2 schematically shows a perspective view of a universal retainer with a received clip according to an exemplary embodiment; and

FIG. 3 shows a perspective view of a universal retainer without a clip according to a further exemplary embodiment.

### DETAILED DESCRIPTION

In automotive engineering, the term “vehicle trim” is usually understood to mean a trim or cover, which can be provided both in the outside region and in the inside region of the vehicle. Vehicle trims are often made of materials such as plastic, metal, leather or composite materials and are used for a number of purposes.

In the outside region of the vehicle, vehicle trims can be provided, for example, in regions of the bumper, the rocker panel, the rear, the wheelhouse, the motor or the underbody in order, for example, to absorb deformation resulting from an accident, to protect sensitive parts such as the motor or electronic systems from dirt, water or other environmental influences, and to improve the aerodynamics of the vehicle.

In the inside region of the vehicle, vehicle trims can be provided, for example, in regions of the interior or of the vehicle doors in order, for example, to improve the acoustics, to increase the safety of the occupants or to improve the inner appearance and the functionality of the interior of the vehicle overall, so that the inside region of the vehicle looks more sporty, more modern or more elegant. Luxury-class vehicles in particular are visually and functionally enhanced by a high-quality interior trim.

Vehicle trims in the inside region of the vehicle are usually fastened to a support component, which serves to support and hold the vehicle trim. The support component can be, for example, the vehicle body itself, a base plate, an inner frame or the inner metal panel of a vehicle component to be covered or trimmed.

The vehicle trim is usually mounted on the support component by a plurality of clips. Such clips are usually made of plastic or metal and serve primarily to fasten the vehicle trim to the support component.

Thus, by the clips, the vehicle trim is securely held and fastened in place on the support component so that vibrations and rattling noises are prevented during driving.

Such clips are received in a holder specially designed for this purpose, called a retainer. Such retainers are usually injection-molded on the rear of the vehicle trim.

DE 10 2013 209 078 A1 discloses a method for molding a clip holder. JP2013035322 A1 discloses an assembly structure for vehicle interior materials.

A disadvantage of the retainers currently known from the prior art is that they each have a thick separating wall. This separating wall results in a considerable additional material expenditure per retainer and thus a higher overall weight of the vehicle. In particular in the case of a multiplicity of vehicle trims in the interior, this results in increased manufacturing costs, disadvantageous driving behavior and increased fuel consumption.

Furthermore, the retainers currently known from the prior art are geometrically very disadvantageously designed. In the manufacturing, two tool halves of a slide molding tool are closed to form a cavity for manufacturing the retainer, the cavity being divided by the disadvantageous thick separating wall in two mutually separated hollow spaces. Then a molding material in flowable form is introduced into the cavity or into the two mutually separated hollow spaces. After the molding material has hardened, the hardened molding material, i.e., the retainer, is demolded. For this purpose, the two tool halves are separated by moving the two tool halves in opposite directions to one another.

The retainers currently known from the prior art are geometrically disadvantageously designed because they are designed based on two demoldings, in particular two demolding directions, which lie on a common demolding axis. As a result, the geometric design of the retainers is significantly restricted.

In particular vehicle trims in regions of the vehicle doors, also called door trims, must be fastened to the inner metal door panel by a multiplicity of clips because of the high weight of the vehicle trim.

The contact surfaces of the inner metal door panels standardly always run parallel to an XZ-plane of the vehicle, the X-axis being oriented along the longitudinal axis of the vehicle, in particular in the direction of travel, the Y-axis being oriented along the transverse axis of the vehicle, in particular in the direction of the vehicle interior, and the Z-axis being oriented along the vertical axis of the vehicle, in particular upward in the direction of the vehicle roof.

In other words, due to the fact that the retainers, which receive the clips and in particular are injection-molded on the rear of the vehicle trim, the two tool halves of the slide tool must likewise necessarily be moved in the XZ-plane of the vehicle due to the standardized orientation of the contact surfaces of the support component, in particular the inner metal door panel.

Since, however, for design reasons vehicle trims, in particular door trims, never always run straight or parallel to the XZ-plane of the vehicle, the retainers currently known from the prior art cannot be injection-molded onto the rear of every vehicle trim, because the slide direction of the two tool halves of the slide molding tool is often inconsistent with the curve contour of the vehicle trim.

In other words, retainers currently known from the prior art cannot be injection-molded on a vehicle trim having a complex geometry, due to the standardized parallel orientation of the contact surfaces of support components, in particular inner metal door panels, with respect to the XZ-plane of the vehicle and due to the orientation of the two demolding directions on a common demolding axis.

To solve this problem, in the prior art additional holding parts are attached to the vehicle trim such that the clips are received by the additional holding parts at a certain angle. However, the use of such additional holding parts leads again to a considerable additional material expenditure per retainer and thus to a higher overall weight. In particular in the case of a multiplicity of vehicle trims in the interior, this results in increased manufacturing costs.

Therefore it is the object of the disclosed embodiments to at least partially overcome the aforementioned disadvantages for a retainer. In particular, it is the object of the disclosed embodiments to provide an improved and more economical retainer by which a vehicle trim can be fastened to a support component in a simple way. It is also the object of the disclosed embodiments to provide an improved and more economical method for manufacturing such a retainer.

Features and details that are described in connection with the universal retainer according to the disclosed embodiments are of course also valid in connection with the method according to the disclosed embodiments, and vice versa, and therefore, with regard to the disclosure relating to the individual aspects of the disclosed embodiments, mutual reference always is or can be made.

According to the first aspect of the disclosed embodiments, the object is thus achieved by a universal retainer for fastening a vehicle trim of a transportation vehicle, in particular a door trim, to a support component, in particular an inner metal door panel,
the universal retainer being composed of a first, upper retainer part and a second, lower retainer part,
wherein the first, upper retainer part has a first joint surface and the second, lower retainer part has a second joint surface,
wherein the first joint surface and the second joint surface directly adjoin one another in a common separation plane over the entire joint region to form the universal retainer,
wherein the first, upper retainer part has a first demolding axis, which is defined by a demolding by a first slide molding tool along a first demolding direction,
wherein the second, lower retainer part has a second demolding axis, which is defined by a demolding by a second slide molding tool along a second demolding direction,
wherein the first demolding axis and the second demolding axis are oriented differently from one another, in particular include a demolding differential angle with one another.

Firstly, the core idea of the disclosed embodiments is to provide a universal retainer that does not have a thick separating wall as in the prior art.

For this purpose, according to the disclosed embodiments the universal retainer is formed by two halves. According to the disclosed embodiments, the universal retainer is composed in particular of a first, upper retainer part and a second, lower retainer part. The first, upper retainer part has a first joint surface and the second, lower retainer part has a second joint surface.

According to the disclosed embodiments, it is explicitly provided that the first joint surface and the second joint surface directly adjoin one another in a common separation plane over the entire joint region to form the universal retainer, so that a thick separating wall can be dispensed with.

Dispensing with this thick separating wall results in considerable material savings per retainer and thus a significantly lower overall weight. In particular in the case of a multiplicity of vehicle trims in the interior, this results in significantly lower manufacturing costs, more advantageous driving behavior and significantly lower fuel consumption.

Secondly, the core idea of the disclosed embodiments is that the universal retainer, in particular the first, upper retainer part and the second, lower retainer part are joined in such a way that the first, upper retainer part has its own first demolding axis, which is defined by a demolding by a first slide molding tool along a first demolding direction, and the second, lower retainer part likewise has its own second demolding axis, which is defined by a demolding by a second slide molding tool along a second demolding direction.

According to the disclosed embodiments, it is explicitly provided that the first demolding axis and the second demolding axis are oriented differently from one another, in particular include a demolding differential angle with one another.

In other words, a universal retainer is provided, the geometric design of which is no longer restricted and thus can be flexibly adapted, because the universal retainer is now designed based on two different demoldings, in particular two different demolding directions, which lie on different demolding axes.

Because the demolding axes are oriented differently, in particular it is possible to injection-mold the universal retainer according to the disclosed embodiments, in adapted form, onto any vehicle trim, in particular onto a vehicle trim of complex geometry, regardless of the vehicle type, vehicle manufacturer and vehicle model, while the standardized parallel orientation of the contact surface of a support component in the XZ-plane of the vehicle can still be taken into account.

In other words, the disclosed embodiments describes a special geometry of a retainer which, because of its very advantageous demolding concept, in particular its two differently oriented demolding axes, can be universally injection-molded onto any geometry of a vehicle trim, in particular a door trim. The retainer is divided into two parts: a first, upper retainer part, which is provided for receiving a clip, and a second, lower retainer part, which is provided for connection to a vehicle trim.

In particular the contact surfaces of an inner metal door panel always standardly run parallel to an XZ-plane of the vehicle for production reasons. To ensure an exact orientation of the door trim on the inner metal door panel, in particular with accurate fit, the first, upper retainer part optionally has a mounting surface with an insertion receptacle for the insertion and receiving of a clip, the mounting surface running parallel or essentially parallel to the first demolding axis, in particular parallel or essentially parallel to a contact surface of the inner metal door panel. It is conceivable that only part of the mounting surface runs parallel or essentially parallel to a contact surface of the inner metal door panel.

Optionally, the second, lower retainer part has a connection surface for fixed connection to a trim component rear surface of the trim, and the contour of the connection surface in the connection region corresponds essentially, optionally completely, to the contour of the trim component rear surface. This can allow the slide direction of the two tool halves of the slide molding tool to be flexibly adapted to the curve contour of the vehicle trim.

The universal retainer according to the disclosed embodiments is composed of two integrally joined parts, in particular a first, upper retainer part and a second, lower retainer part. For this purpose, the first, upper retainer part has a first joint surface and the second, lower retainer part has a second joint surface, and it is explicitly provided that the first joint surface and the second joint surface directly adjoin one another in a common separation plane over the entire joint region to form the universal retainer.

The inclination of this separation plane defines the flexible, in particular universal, suitability of the universal retainer according to the disclosed embodiments. The inclined separation plane enables in particular greater design freedom in shaping. As a result of the inclined separation plane, it is possible to realize complex geometries which would otherwise be impossible or difficult to demold without such an inclined separation plane. The inclined separation plane also makes it possible to remove the manufactured universal retainer from the slide molding tool more easily during demolding, because the inclined separation plane reduces the friction resistance that arises as the two tool halves of the slide molding tool are being pulled out. Furthermore, the inclined separation plane reduces the risk of damage to the universal retainer.

The common separation plane optionally runs essentially parallel to the second demolding direction of the second, lower retainer part. However, it is also conceivable that, because of a tool spotting region, the common separation plane does not run parallel to the second demolding direction of the second, lower retainer part, but rather differs from the second demolding direction of the second, lower retainer part by at least 5, optionally at least 7, degrees.

The core concept of the disclosed embodiments is to provide a universal retainer which does not have a thick separating wall as in the prior art. The first, upper retainer part and the second, lower retainer part optionally form a common hollow space within the universal retainer. As a result of the common hollow space, considerable material savings per retainer can be achieved and thus a significantly lower overall weight can be achieved. In particular in the case of a multiplicity of vehicle trims, in particular door trims, this results in significantly lower manufacturing costs, more advantageous driving behavior and significantly lower fuel consumption.

The first, upper retainer part and the second, lower retainer part optionally form a plurality of common reinforcement ribs, which run within the common hollow space. It is conceivable that the first, upper retainer part and the second, lower retainer part form only one common reinforcement rib.

The reinforcement ribs are in particular formed by the first, upper retainer part and the second, lower retainer part and run within the common hollow space. The common reinforcement ribs optionally each have a support surface for supporting the clip.

Optionally, the first, upper retainer part and the second, lower retainer part are joined by an injection-molding method.

According to a second aspect, a method, in particular an injection-molding method, for manufacturing, in particular demolding, a universal retainer according to the disclosed embodiments is provided.

The method according to disclosed embodiments may include the following method operations:
moving a first slide molding tool and a second slide molding tool relative to one another from an initial position into an injection position, so that the first slide molding tool and the second slide molding tool form a cavity which shapes the universal retainer, wherein the first slide molding tool forms the shape of a first, upper retainer part of the universal retainer and the second slide molding tool forms the shape of a second, lower retainer part of the universal retainer, wherein the first slide molding tool can be moved along a first demolding direction and the second slide molding tool can be moved along a second demolding direction, wherein the first demolding direction and the second demolding direction differ from one another, in particular include a demolding differential angle with one another,
injecting a flowable molding material, in particular a molten resin or plastic, into the cavity, such that the flowable molding material completely fills the cavity,
letting the flowable molding material harden in the cavity, and
demolding the universal retainer, in particular the first, upper retainer part and the second, lower retainer part, by moving the first slide molding tool and the second slide molding tool relative to one another from the injection position back into the initial position.

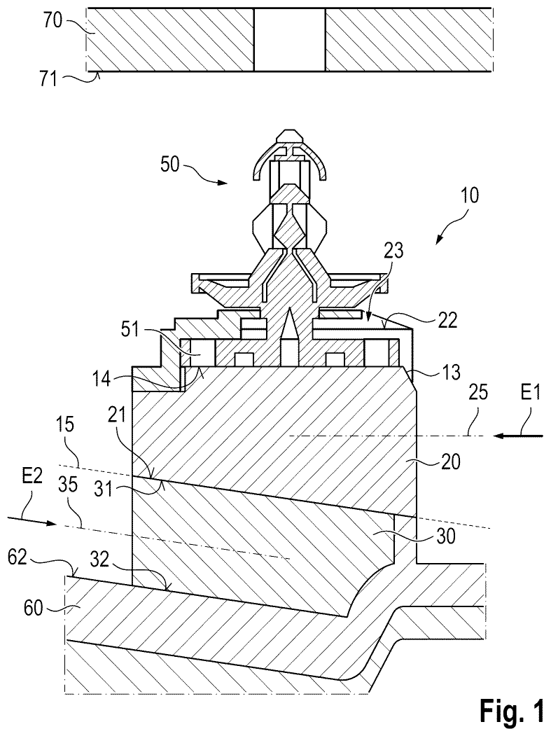

FIG. 1 shows a side view of a universal retainer 10 for receiving a clip 50 for fastening a vehicle trim 60 of a transportation vehicle, in particular a door trim, to a support component 70, in particular an inner metal door panel.

As can be clearly seen in FIG. 1, the universal retainer 10 is composed of a first, upper retainer part 20 and a second, lower retainer part 30. The universal retainer 10, in particular the first, upper retainer part 20 and the second, lower retainer part 30, is integrally joined by an injection-molding method. The universal retainer 10, in particular the first, upper retainer part 20 and the second, lower retainer part 30, can be made of a thermoplastic resin or of plastic.

The first, upper retainer part 20 and the second, lower retainer part 30 are integrally joined by virtue of the fact that a first demolding is accomplished by a first slide molding tool and a second demolding is accomplished by a second slide molding tool.

The first slide molding tool forms the shape of the first, upper retainer part 20 of the universal retainer 10, and the second slide molding tool forms the shape of the second, lower retainer part 30 of the universal retainer 10.

The first, upper retainer part 20 has a first demolding axis 25, which is defined by a demolding by the first slide molding tool along a first demolding direction E1. The second, lower retainer part 30 has a second demolding axis 35, which is defined by a demolding by the second slide molding tool along a second demolding direction E2.

The first demolding axis 25 and the second demolding axis 35 are oriented differently from one another, such that the first demolding axis 25 and the second demolding axis 35 include a demolding differential angle with one another.

In the context of the disclosed embodiments, the X-axis is defined along the longitudinal axis of the vehicle, in particular in the direction of travel, the Y-axis is defined along the transverse axis of the vehicle, in particular in the direction of the vehicle interior, and the Z-axis is defined along the vertical axis of the vehicle, in particular upward in the direction of the vehicle roof.

Generally, the demolding differential angle is greater than 0°, the first demolding axis 25 being oriented essentially parallel to an XZ-plane of the vehicle and the second demolding axis 35 being oriented differently therefrom, if the vehicle trim 60 is a door trim and the support component 70 is an inner metal door panel.

It is also conceivable that the demolding differential angle is negative, in particular less than 0°.

It is also conceivable that the first demolding axis 25 and/or the second demolding axis 35 is not oriented parallel to an XZ-plane of the vehicle, but rather is oriented parallel to the YZ-axis or parallel to the XZ-axis of the vehicle, if the vehicle trim 60 is another vehicle trim, in particular an interior trim, and the support component 70 is another vehicle component.

The demolding differential angle describes the angle that the first demolding axis 25 and the second demolding axis 35 include with one another. The demolding differential angle is dependent on the geometry of the vehicle trim 60 and on the geometry of the support component 70 and can be specifically adapted to any vehicle type, vehicle manufacturer and vehicle model.

In other words, the demolding differential angle is particularly decisive in the design of the universal retainer 10 according to the disclosed embodiments, because the demolding differential angle determines the flexible design and shapeability of the universal retainer 10 according to the disclosed embodiments. The demolding differential angle can, for example, also improve the flow behavior during the manufacturing process.

Because the first demolding axis 25 and the second demolding axis 35 are oriented differently from one another according to the disclosed embodiments, it is possible to variably adjust the molding requirements of the universal retainer 10.

In other words, it is no longer necessary to observe a superordinate common demolding direction, but rather each half of the universal retainer 10, i.e., the first, upper retainer part 20 and the second, lower retainer part 30, can be variably adapted to the corresponding geometric requirements independently of one another.

Since the first demolding axis 25 and the second demolding axis 35 are oriented differently from one another, in particular include a demolding differential angle with one another, it is accordingly also possible to produce more complex shapes of the universal retainer 10 without having to provide additional holding parts or disadvantageous common drafts for a common demolding direction. This results in considerably greater freedom in the shaping of the universal retainer 10. At the same time, the universal retainer 10 can be manufactured with less material even in the case of complex shapes, so that additional machining effort and additional material and high weight of the universal retainer 10 are avoided.

The first, upper retainer part 20 has a first joint surface 21. The second, lower retainer part 30 has a second joint surface 31. The first joint surface 21 and the second joint surface 31 directly adjoin one another in a common separation plane 15 over the entire joint region to form the universal retainer 10.

The common separation plane 15 is not a separation plane in the sense of a physical separation plane or separating wall which divides the universal retainer 10 into two hollow spaces separated from one another, but rather defines a conceptual joint plane in which the first joint surface 21 and the second joint surface 31 directly adjoin one another over the entire joint region to form the universal retainer 10, and therefore a physical separating wall can be specifically and deliberately dispensed with. In other words, the two slide molding tools slide directly on one another during the joining.

Dispensing with this separating wall, in particular thick separating wall, results in considerable material savings and thus a significantly lower overall weight.

The common separation plane 15, which in particular is inclined, enables greater design freedom in shaping. As a result of the common separation plane 15, in particular complex geometries of the universal retainer 10 which would otherwise be impossible or difficult to demold without such an inclined separation plane 15 can be realized.

The first, upper retainer part 20 serves to receive the clip 50.

The first, upper retainer part 20 has a mounting surface 22 with an insertion receptacle 23 for the insertion and receiving of the clip 50, the mounting surface 22 running parallel or essentially parallel to the first demolding axis 25 and parallel or essentially parallel to a contact surface 71 of the support component 70, in particular to a contact surface of the inner metal door panel.

The second, lower retainer part 30 serves to connect the universal retainer 10 to the vehicle trim 60.

The second, lower retainer part 30 has a connection surface 32 for fixed connection to a trim component rear surface 62 of the vehicle trim 60, and the contour of the connection surface 32 in the connection region corresponds essentially, optionally completely, to the contour of the trim component rear surface 62.

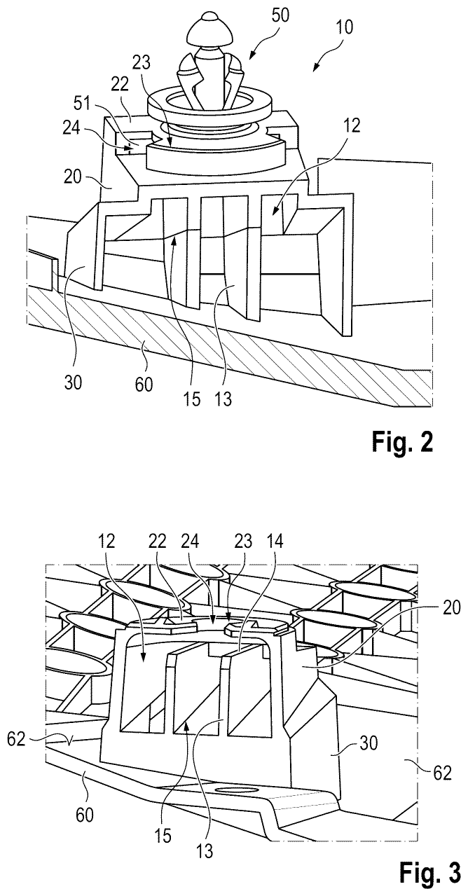

FIG. 2 shows a perspective view of a universal retainer 10 with a received clip 50 according to an exemplary embodiment of the disclosed embodiments.

As can be clearly seen in FIG. 2, the first, upper retainer part 20 has a mounting surface 22 with an insertion receptacle 23 for the insertion and receiving of the clip 50, the mounting surface 22 running parallel or essentially parallel to the first demolding axis 25 and parallel or essentially parallel to a contact surface 71 of the support component 70, in particular to a contact surface of the inner metal door panel.

In particular, the contact surfaces of an inner metal door panel always standardly run parallel to an XZ-plane of the vehicle for production reasons.

Because the mounting surface 22 runs parallel to the first demolding axis 25 and parallel to a contact surface 71 of the support component 70, in particular a contact surface of the inner metal door panel, an exact orientation of the vehicle trim, in particular door trim, on the support component 70, in particular inner metal door panel, in particular with accurate fit, can be ensured.

The mounting surface 22 can optionally also have an insertion opening 24 through which the end of the clip 50, in particular the shaft 51 of the clip 50, can be led. The insertion opening 24 can optionally be in the form of a type of through-hole and have a cutout in some regions.

Because of the cutout, the clip 50 can be optionally lockably inserted into and received in the insertion receptacle 23 when the shaft 51 of the clip 50 is led through the insertion opening 24. As a result, the clip 50 can move to a certain extent for tolerance compensation.

FIG. 3 shows a perspective view of a universal retainer 10 without a clip 50 according to a further exemplary embodiment of the disclosed embodiments.

As can be clearly seen in FIG. 3, the first, upper retainer part 20 and the second, lower retainer part 30 form a common hollow space 12 within the universal retainer 10.

As a result of the common hollow space 12, considerable material savings can be achieved and thus a significantly lower overall weight can be achieved. In particular in the case of a multiplicity of vehicle trims, in particular door trims, this results in significantly lower manufacturing costs, more advantageous driving behavior and significantly lower fuel consumption.

As can also be clearly seen in FIG. 3, the first, upper retainer part 20 and the second, lower retainer part 30 form a plurality of common reinforcement ribs 13, which run within the common hollow space 12. The reinforcement ribs 13 are in particular jointly formed by the first, upper retainer part 20 and the second, lower retainer part 30.

It is conceivable that the first, upper retainer part 20 and the second, lower retainer part 30 form only one single common reinforcement rib 13.

The reinforcement ribs 13 are in particular structural elements of the universal retainer 10 according to the disclosed embodiments for increasing the strength and stiffness of the universal retainer according to the disclosed embodiments.

As a result of the reinforcement ribs 13, in particular the load-bearing capacity of the universal retainer 10 according to the disclosed embodiments for supporting the clip 50 can be significantly improved, since the loads are distributed more evenly, so that deformation and fractures are prevented.

The shape and arrangement of the reinforcement ribs 13 can vary. The reinforcement ribs 13 can be designed with different geometries, such as straight, curved or branched ribs, to meet the specific requirements of the structure.

The common reinforcement ribs 13 each have a support surface 14 for supporting the clip 50. In particular the shaft 51 of the clip 50 lies directly on the support surfaces 14, so that the clip 50 is not only received by the insertion receptacle 23 but is additionally supported by the reinforcement ribs 13.

### LIST OF REFERENCE SIGNS

10 Universal retainer
12 Common hollow space
13 Reinforcement ribs
14 Support surfaces of the reinforcement ribs
15 Common separation plane
20 First, upper retainer part
21 First joint surface
22 Mounting surface
23 Insertion receptacle
24 Insertion opening
25 First demolding axis
30 Second, lower retainer part
31 Second joint surface
32 Connection surface
35 Second demolding axis
50 Clip
60 Vehicle trim
62 Trim component rear surface
70 Support component
71 Contact surface of the support component
E1 First demolding direction
E2 Second demolding direction
100 Method

1. A universal retainer for receiving a clip for fastening a vehicle trim of a transportation vehicle to an inner metal door panel, the universal retainer comprising:
a first, upper retainer part; and
a second, lower retainer part,
wherein the first, upper retainer part has a first joint surface and the second, lower retainer part has a second joint surface,
wherein the first joint surface and the second joint surface directly adjoin one another in a common separation plane over the entire joint region to form the universal retainer,
wherein the first, upper retainer part has a first demolding axis, which is defined by a demolding by a first slide molding tool along a first demolding direction,
wherein the second, lower retainer part has a second demolding axis, which is defined by a demolding by a second slide molding tool along a second demolding direction,
wherein the first demolding axis and the second demolding axis are oriented differently from one another including a demolding differential angle with one another.

2. The universal retainer of claim 1, wherein the first, upper retainer part has a mounting surface with an insertion receptacle for the insertion and receiving of the clip, the mounting surface running parallel or essentially parallel to the first demolding axis.

3. The universal retainer of claim 1, the second, lower retainer part has a connection surface for fixed connection to a trim component rear surface of the vehicle trim, and the contour of the connection surface in the connection region corresponds to the contour of the trim component rear surface.

4. The universal retainer of claim 1, wherein the common separation plane runs essentially parallel to the second demolding direction of the second, lower retainer part.

5. The universal retainer of claim 1, wherein the first, upper retainer part and the second, lower retainer part form a common hollow space within the universal retainer.

6. The universal retainer of claim 1, wherein the first, upper retainer part and the second, lower retainer part form a plurality of common reinforcement ribs, which run within the common hollow space.

7. The universal retainer of claim 6, wherein the common reinforcement ribs each have a support surface for supporting the clip.

8. The universal retainer of claim 1, wherein the first, upper retainer part and the second, lower retainer part are integrally joined by an injection-molding method.

9. An injection-molding method for manufacturing a universal retainer, the method comprising the following method operations:
moving a first slide molding tool and a second slide molding tool relative to one another from an initial position into an injection position, so that the first slide molding tool and the second slide molding tool form a cavity which shapes the universal retainer, wherein the first slide molding tool forms the shape of a first, upper retainer part of the universal retainer and the second slide molding tool forms the shape of a second, lower retainer part of the universal retainer, wherein the first slide molding tool can be moved along a first demolding direction and the second slide molding tool can be moved along a second demolding direction, wherein the first demolding direction and the second demolding direction differ from one another, in particular include a demolding differential angle with one another,
injecting a flowable molding material, in particular a molten resin or plastic, into the cavity, such that the flowable molding material completely fills the cavity,
letting the flowable molding material harden in the cavity, and
demolding the universal retainer, in particular the first, upper retainer part and the second, lower retainer part, by moving the first slide molding tool and the second slide molding tool relative to one another from the injection position back into the initial position.

10. The method of claim 9, wherein the universal retainer is configured to receive a clip for fastening a vehicle trim of a transportation vehicle door trim to an inner metal door panel, the universal retainer being composed of a first, upper retainer part and a second, lower retainer part, wherein the first, upper retainer part has a first joint surface and the second, lower retainer part has a second joint surface, wherein the first joint surface and the second joint surface directly adjoin one another in a common separation plane over the entire joint region to form the universal retainer, wherein the first, upper retainer part has a first demolding axis, which is defined by a demolding by a first slide molding tool along a first demolding direction, wherein the second, lower retainer part has a second demolding axis, which is defined by a demolding by a second slide molding tool along a second demolding direction, wherein the first demolding axis and the second demolding axis are oriented differently from one another including a demolding differential angle with one another.

11. The method of claim 10, wherein the first, upper retainer part has a mounting surface with an insertion receptacle for the insertion and receiving of the clip, the mounting surface running parallel or essentially parallel to the first demolding axis.

12. The method of claim 10, the second, lower retainer part has a connection surface for fixed connection to a trim component rear surface of the vehicle trim, and the contour of the connection surface in the connection region corresponds to the contour of the trim component rear surface.

13. The method of claim 10, wherein the common separation plane runs essentially parallel to the second demolding direction of the second, lower retainer part.

14. The method of claim 10, wherein the first, upper retainer part and the second, lower retainer part form a common hollow space within the universal retainer.

15. The method of claim 10, wherein the first, upper retainer part and the second, lower retainer part form a plurality of common reinforcement ribs, which run within the common hollow space.

16. The method of claim 15, wherein the common reinforcement ribs each have a support surface for supporting the clip.

17. The method of claim 10, wherein the first, upper retainer part and the second, lower retainer part are integrally joined by an injection-molding method.
